(19) United States
(12) Patent Application Publication
(10) Pub. No.: US 2006/0034544 A1
(43) Pub. Date: Feb. 16, 2006

(54) Distinctness of image processing

(75) Inventor: Ming-Kai Tse, Lexington, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: QUALITY ENGINEERING, INC.

(21) Appl. No.: 11/204,752

(22) Filed: Aug. 15, 2005

Related U.S. Application Data
(60) Provisional application No. 60/678,460, filed on May 6, 2005.
(60) Provisional application No. 60/674,360, filed on Apr. 22, 2005.
(60) Provisional application No. 60/601,220, filed on Aug. 13, 2004.

(51) Int. Cl. G06K 9/46

(52) U.S. Cl. 382/286

(57) ABSTRACT

A distinctness of image processing system comprising a portable unit having an imaging portion and a processing portion means associated with said imaging portion for projecting a edge upon to an image surface located substantially on a bottom plane of said unit and further including means for sensing said image edge applied to said plane when said unit is applied to a surface under test, said sensing unit providing an electrical signal to said processing portion; and said processing portion having means for allowing operator selection of a test function and display of test function results on a screen thereof.

### CROSS REFERENCE TO RELATED APPLICATIONS

This application claims the benefit under 35 U.S.C. § 119(e) of U.S. Provisional Application No. 60/678,460 filed on May 6, 2005, U.S. Provisional Application No. 60/674,360 filed on Apr. 22, 2005, and Provisional Application No. 60/601,220 filed on Aug. 24, 2004, the disclosures of which are incorporated by reference herein.

### BACKGROUND OF THE INVENTION

In printing of documents and images from computer sources on laser and ink jet printers, the quality and resolution as well as consistency of the image becomes increasingly important. This is particularly so in reproduction of images having fine detail or with small font size prints.

The quality of the image is a function not only of the printer quality and characteristics including print head characteristics but importantly of the quality of the actual paper, whether by not a normal soft surface fiber based paper or a more glossy paper designed for printing color images. Accordingly, it is important to be able to determine the ultimate print quality, or as used herein, “distinctness of image.” This is important both for quality control and the production of papers in production plants as well as for user selection and buying decisions in office, retail and wholesale environments.

### BRIEF SUMMARY OF THE INVENTION

The present invention provides a portable, field usable electronic imaging sensor device for evaluating the distinctness of image (DOI) capabilities of a print paper sample. The invention projects a black to white transition edge, or plural such edges, onto the test paper from the portable unit. An image sensor receives the image and converts it to an electrical representation which is applied to a computer or other processing mechanism. The computer processor will produce a line chart representing the transition from dark to light or vice versa for the edge. The slope of that transition is typically very steep for high quality photographic papers but becomes substantially more shallow with the use of softer surface or fiber surface papers. This evaluation is fast and can be applied at various points over a sample paper piece or plural samples in order to check for not only quality but sample to sample consistency.

The processor can be programmed to provide other functions in the analysis of the image received with other data relevant to the paper attributes provided.

### BRIEF DESCRIPTION OF THE SEVERAL VIEWS OF THE DRAWINGS

FIG. 1 is a system block diagram of a distinctness of image tester according to the invention;

FIG. 2 illustrates an edge image used for projection onto test paper in use of the present invention;

FIG. 3 is an overview of a portable processor placed over a test paper according to the invention;

FIG. 4 illustrates a field of view for the tester of FIG. 2 for use in the invention;

FIG. 5 illustrates a transition between light and dark as applied to a paper under test and processed by the system of FIG. 1;

FIG. 6 is a perspective view of a portable, hand held device for providing onsite distinctness of image paper testing according to the invention; and

FIGS. 7 and 8 illustrate processor steps in the use of the invention.

### DETAILED DESCRIPTION OF THE INVENTION

The characteristics of paper used in printing, such as in photographic or other image printing varies from supplier to supplier and is dependent upon manufacturing processes and other factors. The present invention provides a system for analyzing such paper to provide a quantitative designation of properties useful for understanding its abilities to present printed images effectively.

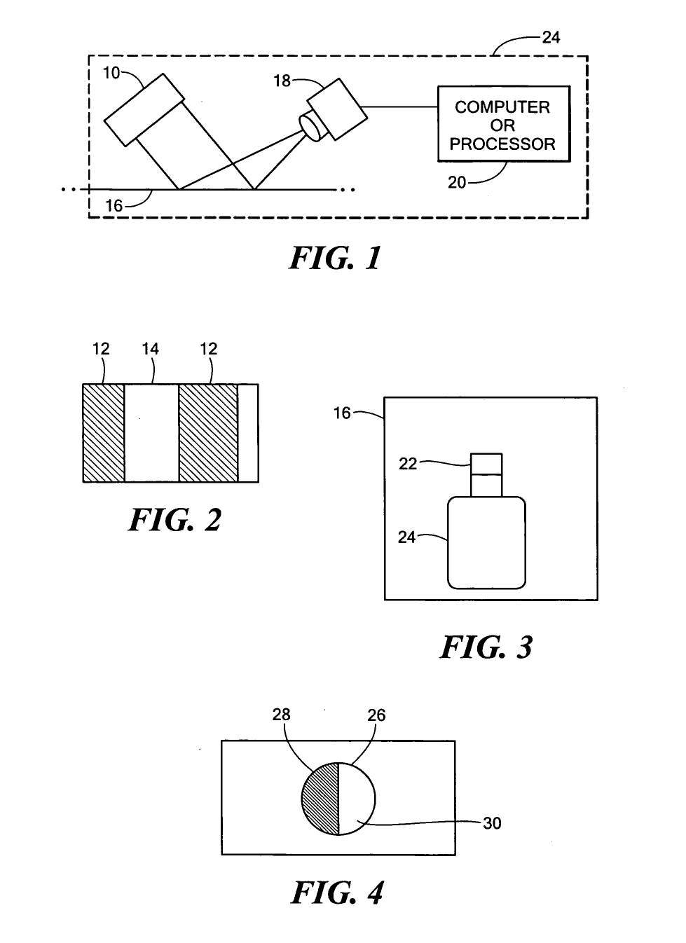

The system uses reflection of light from a surface of such paper, either before or after printing, the apparatus may include the apparatus shown in FIG. 1 wherein an image source 10 projects an image, typically at close to 45°, such as the alternating solid black and white lines 12 and 14 of FIG. 2 onto paper 16 under test. The image is received in a digital image processor such as a camera or a video monitor 18 where it is processed in a computer 20. The processing of the computer 20 will be described below. The image source 10 can have its image changed if it is an LCD display by the computer 20 to any of a range of selected images. Alternately, an electromechanical projection system can be used instead.

The system can be fixed into a test module or can alternatively use a hand held unit such as shown in FIG. 3 which has a head 22 attached as an extension of a body 24 and extending over paper 16. The head 22 projects an image such as a circle of light 26 shown in FIG. 4 having a black portion 28 such as a solid black portion and a white portion 30 such as a pure white portion. Processing electronics and general programming capabilities are disclosed in U.S. patent application Ser. No. 10/416,876, incorporated herein by reference.

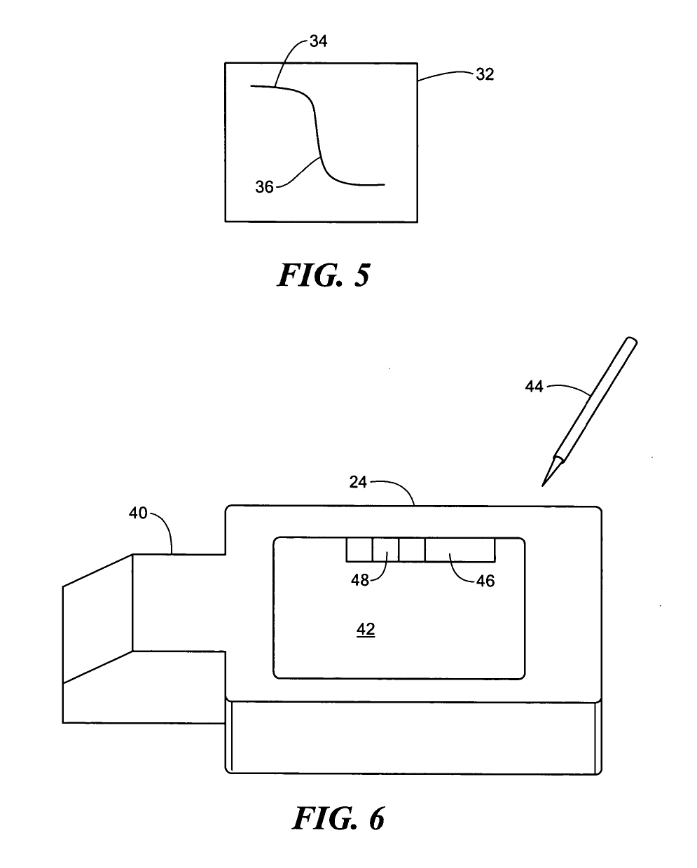

The processor 20 can provide a number of quantified data, using for example an intensity plot 32 shown in FIG. 5. A curve 34 illustrates the change between black and white portions of the exemplary images of FIG. 2 or 3. A high quality paper will provide a very sharp and crisp transition 36 whereas a low quality paper can provide only a very shallow slope transition. The ideal would of course be an abrupt square wave transition. Known processing techniques can be used by processor 20 to provide quantified data such as maximum and average slope in the region 36, the roughness or noise level in the image curve 34, color wavelengths and inconsistencies throughout different test spots among many other testable parameters to provide a quantifiable set of data for characterizing such papers. Additionally, the actual maximum and minimum levels of curve 34 can indicate the level of saturation in printed images. All these allow calibration or standardization between papers or use as paint samples.

As illustrated in FIG. 6, the hand held unit 24 has a neck portion 40 in which optics are provided to accomplish the functions of the image source 10, imaging plane 16 and sensor 18 according to the invention. A screen 42, such as is found in palm top processors is provided and functions can be activated through a stylist 44 by tapping upon selected portions of the display 42 to initiate a test such as to display the graph of FIG. 5, and/or test for other features such as saturation level, numerically present the slope of the curve 34 and/or 36 at various points, provide noise level (point by point deviation from expected values), color wavelengths, and data comparison between plural test sites to determine statistical variance statistics using known processing techniques. For that purpose, a segment such as segment 46 may be divided into point and pick areas 48 for selecting such data processing and display features.

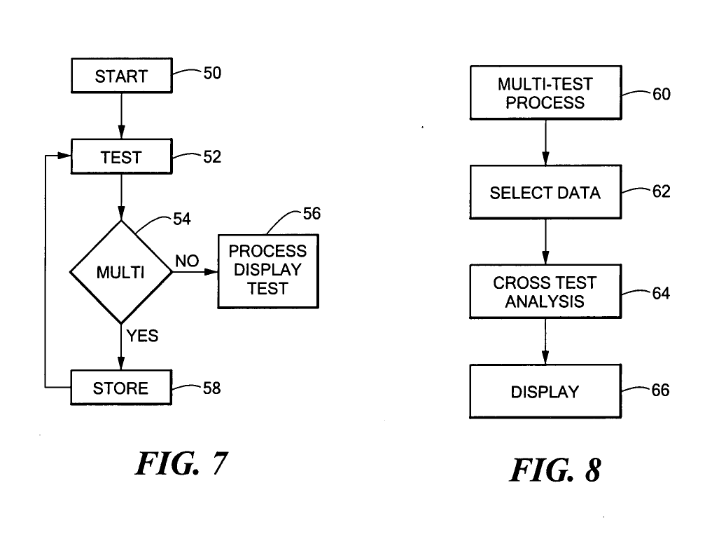

FIG. 7 illustrates a processing cycle for use in the present invention. Beginning from a start state 50 a test is performed in state 52. If just this test is of importance, a store decision in step 54 will proceed to a data processing step 56 to provide selected processing and display of test information. If it is decided to store the data to accumulate multiple points a store data step 58 accomplishes that function. The system may be programmed to provide both steps 56 and 58 so that actual data processing for each test area can be done while data is accumulated for subsequent use in multi-state processing as illustrated in FIG. 8.

In FIG. 8, the system provides a multi-test processing from a state 60. From a step 62 the test range of data stored in step 58 is identified and data within that range is processed in step 64 according to processing features selected on the face of the unit 24. The resulting analysis is displayed in step 66.

The invention is to be interpreted as to scope only in accordance with the following claims and equivalencts thereof.

What is claimed is:

1. A distinctness of image processing device comprising:
a unit having an imaging portion and a processing portion;
means associated with said imaging portion for projecting a edge upon to an image surface located substantially on an imaging plane of said unit and further including means for sensing said image edge applied to said plane when said unit is applied to a surface under test, said sensing unit providing an electrical signal to said processing portion;
said processing portion having means for allowing operator selection of a test function and display of test function results on a screen thereof.

2. The device of claim 1 wherein said imaging portion applies an image of said edge to said imaging plane at an approximately 45° angle and said sensor senses said applied image at approximately a 45° angle.

3. The device of claim 1 wherein said processor portion includes a display screen on a surface thereof away from the imaging plane.

4. The device of claim 1 wherein said function selection includes the functions of edge transition slope processing.

5. The device of claim 1 wherein said functions selectable by said operator includes image edge transition slope statistics, reflected light color wavelengths, and light saturation levels.

6. The device of claim 1 wherein said device is provided in a portable housing.
